(19) United States
(12) Patent Application Publication
(10) Pub. No.: US 2025/0276349 A1
(43) Pub. Date: Sep. 4, 2025

(54) LOADING METHOD FOR LOADING A WASH RACK, TEST METHOD, AUGMENTED REALITY APPARATUS, LOADING SYSTEM AND CLEANING METHOD

(71) Applicant: Belimed Life Science AG, Sulgen (CH)

(72) Inventors: Jochen SCHLAG, Kreuzlingen (CH); Jürgen ALTHAMMER, Kraiburg a. Inn (DE); Adrian LUDWIG, Rikon im Toesstal (CH); Ralf KRETZSCHMAR, Dresden (DE)

(73) Assignee: Belimed Life Science AG, Sulgen (CH)

(21) Appl. No.: 18/859,924

(22) PCT Filed: Apr. 25, 2022
(86) PCT No.: PCT/EP2022/060869

§ 371 Date: Oct. 24, 2024

(51) Int. Cl. B08B 13/00; G02B 27/01

(52) U.S. Cl. CPC B08B 13/00; G02B 27/017; G02B 2027/0178

(57) ABSTRACT

The invention relates to a loading method (10) for loading a wash item carrier (41) for cleaning in a cleaning system. Comprising the steps of: Providing an augmented reality apparatus (1), in particular comprising augmented reality glasses. Providing a wash rack (41). Providing loading instructions by the augmented reality apparatus (1) for loading the wash rack (41), in particular by means of visual representation and/or acoustic instructions. In particular, capturing of completed loading steps, preferably by input by the user and/or by at least one recording device (3) of the augmented reality apparatus (1). Loading of the wash rack (41) with items to be cleaned (42b) by a user according to the given loading instructions.

The invention relates to a loading method for loading a wash rack, a test method for testing the loading, an augmented reality apparatus, a loading system and a cleaning method.

In various areas, such as the chemical industry, the pharmaceutical industry and medicine, the thorough cleaning of materials such as ampoules etc. is of great importance. To ensure thorough, automated cleaning of these items to be cleaned in a cleaning system, they must be arranged in a specific, correct way on a wash rack.

This is done, for example, in a laboratory or production facility by means of manuals, printed or digital drawings that depict the loading of the wash rack using two-dimensional drawings. These drawings or images must be interpreted by the user in such a way that they recognize where an item to be cleaned must be placed on a wash rack. This requires spatial imagination, and the operator must recognize from the drawing or image where which items to be cleaned must be placed and how. In most cases, the drawings do not show the sequence in which loading must take place to make loading as efficient and ergonomic as possible. It is also often difficult to recognize special features that are important for placement, such as whether a glass should be placed with the opening facing upwards or downwards.

It is therefore the task of this invention to overcome the disadvantages of the prior art and to provide a loading method, a test method, a cleaning method, an augmented reality apparatus, a loading system and a cleaning method which allow simple, rapid and correct loading of a wash rack so that the items to be cleaned can be thoroughly cleaned.
This task is solved by a loading method for loading a wash rack for cleaning in a cleaning system. The loading method comprises the steps:
Providing an augmented reality apparatus, preferably a mixed reality apparatus, in particular comprising glasses,
Provide a wash rack,
Providing loading instructions by the augmented reality apparatus for loading the wash rack, in particular by means of visual representation and/or audio instructions,
In particular, capturing completed loading steps, preferably by input by the user and/or by at least one capturing device of the augmented reality apparatus, Loading of the wash rack with items to be cleaned by a user in accordance with the loading instructions issued

This allows wash racks to be loaded quickly and correctly. In this case, augmented reality means that the real world is overlaid with virtual information. Mixed reality is a subtype of augmented reality and in this case means that real and virtual elements interact with each other and the user can interact with virtual elements as in the real world. By using an augmented reality apparatus, the user can better recognize how the items to be cleaned are arranged and understand this quickly.

Loading instructions are instructions to the user on how to correctly load items to be cleaned onto a wash rack. Wash racks are designed to hold items to be cleaned so that they can be thoroughly cleaned. They have sufficient openings to allow cleaning liquids to pass through. Wash racks can be trolleys, baskets and similar containers.

Items to be cleaned are objects that are to be cleaned. Items to be cleaned can be ampoules, tools, clips and similar objects.

The loading method may include a step in which the user has to identify oneself. This can be done by the recording device, for example, by the user speaking their name or identification number or showing their badge. Identification can also be carried out by a visual gesture or movement performed by the user.

Using glasses leaves the user's hands free to load the wash rack according to the loading instructions and/or interact with the loading instructions.

Preferably, loading instructions are displayed to the user by means of virtual representation of 3D models of items to be cleaned and/or the wash rack, preferably of a loaded wash rack, in particular the position and/or arrangement of the items to be cleaned on the wash rack, and/or loading steps are displayed to the user, in particular by means of glasses.

This allows the user to quickly and easily identify the items to be cleaned and the wash rack.

Preferably, the loading steps are displayed in animated form.

This allows the arrangement to be tracked quickly and easily.

Preferably, virtual loading instructions are projected onto or next to real positions of the wash rack by the augmented reality apparatus, in particular by means of glasses. Preferably, a virtual wash rack and/or virtual items to be cleaned are projected onto or next to the real wash rack by the augmented reality apparatus. In particular, animated loading steps are projected onto or next to the wash rack.

This allows the position and arrangement of the items to be cleaned to be imitated and verified quickly and easily. In particular, the user performs a loading step in such a way that the user arranges the real items to be cleaned on the real wash rack in such a way that the virtual items to be cleaned are superimposed on the real items to be cleaned. Preferably, the user adjusts the position and/or arrangement of the real items to be cleaned to the position and/or arrangement of the virtual items to be cleaned, while the virtual loading instructions are projected onto the real positions of the wash rack by the augmented reality apparatus.

In particular, the user arranges the items to be cleaned during loading in such a way that the projected items to be cleaned and the real items to be cleaned have the same position and arrangement or, in the case that the virtual wash rack is projected next to the real wash rack, the position is recognized by the fact that the real wash rack and the virtual wash rack look almost identical.

Preferably, the method comprises the following steps:
Visualizing the items to be cleaned and/or the wash rack,
Collecting the items to be cleaned and/or the wash rack to be used, preferably by a user and/or by a sorting apparatus.

This allows the required items to be cleaned to be found quickly and easily. They can be visualized using virtual 3D models and/or as icons.

Preferably, the augmented reality apparatus comprises at least one recording device for recording information, in particular a camera for recording static and/or moving images and/or a microphone for recording acoustic instructions from the user.

This allows the augmented reality apparatus to be operated easily. The camera may be adapted to record gestures from the user.

Preferably, the items to be cleaned and/or the wash rack comprise positioning features for recognizing the orientation of the items to be cleaned and/or the wash rack, in particular the positioning features are physical features and/or labels, preferably the positioning features are adapted to be captured by the recording device of the augmented reality apparatus.

This allows the positions of real items to be cleaned to be easily and quickly compared with the correct position.

Preferably, the method comprises the following step:
Aligning the 3D models, in particular according to positioning features, by the user, preferably by gestures captured by a recording device of the augmented reality apparatus.

This allows the user to more easily recognize the real items to be cleaned that match the 3D model and the correct arrangement.

Alternatively, the virtual wash rack can be placed freely in space by gestures.

Preferably, the method comprises the following steps:
Selection of loading instructions by the user by means of interaction with the augmented reality apparatus, in particular by means of input by an input device and/or by means of recognition of gestures by the recording device and/or recognition of voices by the recording device,
visualization of the selected loading instructions.

This allows simple and quick operation of the augmented reality apparatus. If gesture input is used, the user can operate the device by hand movements, such as “clicking” on a virtually displayed selection button, to access loading instructions. This allows the user to operate the device intuitively. If voice input is used, the user can operate the device by speaking certain words and/or phrases, such as “step back” to go back one loading step. This leaves the user's hands free to load the wash rack.

Preferably, the method comprises the following steps:
Capturing items to be cleaned and/or the wash rack to be used, in particular capturing by input by a user and/or by recognizing the wash rack by the recording device,
In particular, determining an ideal loading of at least one wash rack with the captured items to be cleaned.

This allows the loading of the wash rack to be configured to the items to be cleaned. “Ideal loading” here means that as many items to be cleaned are placed on the wash rack as possible to ensure thorough cleaning of the items to be cleaned. Alternatively, or additionally, the user or by specification can select a loading that is optimized and aligned with the operator's situation. For example, an optimization in the sense that certain items to be cleaned must not be mixed with other items to be cleaned. This may concern tools from a particular production process that are to be washed and stored together.

Preferably, the method comprises the following steps:
Recognizing positioning features of the captured wash rack and/or items to be cleaned,
aligning the virtual 3D models of the wash rack and/or the items to be cleaned according to these positioning features
visualizing a superimposed representation of the real wash rack and/or items to be cleaned with the aligned virtual 3D models.

This allows easy alignment of the virtual 3D models with the real items to be cleaned. The augmented reality apparatus can be designed to perform this alignment while the user is loading the wash rack.

Preferably, the method comprises the following steps:
Recognizing positioning features of the captured wash rack and/or items to be cleaned,
indicating position corrections of the items to be cleaned by means of the positioning features
correcting the position of the items to be cleaned according to the position correction indication by the user.

This allows the user to easily make a correction. The augmented reality apparatus can provide an indication of the end position, which allows the user to recognize that the items to be cleaned have reached the correct end position. This end indication can be provided by color change and/or audio signal.

Preferably, the augmented reality apparatus comprises at least one speaker and/or one earphone for reproducing acoustic loading instructions.

As an alternative or in addition to visualizing position corrections, auditory correction instructions can be output. This allows details or certain positioning features to be pointed out.

Preferably, the items to be cleaned and/or the wash rack comprise at least one identification feature for identifying the items to be cleaned and/or the wash rack, in particular markings and/or physical features and/or labels, which can preferably be detected by the recording device.

This makes it possible to ensure where which items to be cleaned were loaded onto a wash rack and cleaned. The identification features can be QR codes. However, the items to be cleaned can also be identified by their optical features only.

Preferably, the loading method comprises the following steps:
Providing a database, wherein the database comprises loading instructions for loading wash racks.

This allows quick access to correct positioning of items to be cleaned. The database may be part of the augmented reality apparatus and/or part of a server. The augmented reality apparatus may include a communication device for communicating with a server.

In addition, the augmented reality apparatus can have digital interfaces to a cleaning system so that data can be transmitted to the cleaning system. In particular, the augmented reality apparatus can issue a release for cleaning to the cleaning system. This can, for example, prevent the cleaning system from starting the cleaning process even though the augmented reality apparatus has not yet logged the final loading process. The cleaning system can offer the option of saving the data recorded by the augmented reality apparatus in order to link the cleaning data with the loading data. This does not have to be done directly on the cleaning system but can also be done on an external server or computer that processes and/or stores the data.

Preferably, the database comprises virtual 3D models of real items to be cleaned and/or of real wash racks. Preferably, the virtual 3D models comprise identical positioning features and/or identification features as the real items to be cleaned and/or the real wash rack.

This allows easy and quick recognition of the items to be cleaned and the wash rack and the correct arrangement.

Preferably, the loading instructions include information on additional cleaning devices to be used, preferably additional nozzles, for specific items to be cleaned. In particular, the loading instructions include details of positioning and/or arrangement and/or mounting of the additional cleaning device to be used. The loading method comprises the step of:
Positioning and/or arranging and/or mounting of at least one additional cleaning device to be used by the user according to the loading instructions.

In this way, the correct cleaning of items to be cleaned that are difficult to clean can be easily ensured. The loading instructions may include warnings indicating particular difficulties in the correct arrangement, in particular acoustic warnings.

Preferably, the wash rack and the items to be cleaned are recorded by the recording device, in particular during loading of the wash rack and/or after completion of loading of the wash rack. Preferably, the recording is started by an input from the user. The recording is stored on a log server on the recording device and/or on a cleaning system.

In so doing, it can be traced at a later time whether the items to be cleaned have been cleaned correctly.

Preferably, the user interacts with the loading instructions, preferably by means of gestures or verbal commands, which are recorded by a recording device and/or can be entered by an input device.

For example, the user can rotate and turn the wash carrier to easily see where and how the items to be cleaned are arranged. The input device can be a wristwatch, a mouse, a keyboard or similar. The augmented reality apparatus may comprise an input device, in particular one or more tactile input functions (such as buttons or a keyboard), for interacting with the augmented reality apparatus, in particular the glasses.

The problem is further solved by a test method for testing the loading of a wash rack. The test method comprises the steps:
Loading a wash rack, in particular by means of a loading method according to one of the preceding claims,
In particular, starting the test, preferably by input by the user, in particular by means of a recording device of an augmented reality device, preferably by a camera and/or a microphone,
capturing the loading of the wash rack, preferably by an augmented reality apparatus, in particular by a recording device of the augmented reality apparatus and/or a recording device of the cleaning system,
Check whether the wash rack is correctly loaded,
If the wash rack is not loaded correctly, issue a warning, otherwise issue a release for cleaning, in particular by means of the augmented reality apparatus.

This allows the loading of the wash rack to be verified quickly. The release for cleaning can be given to the user and/or to a cleaning system.

Preferably, the test method comprises the following steps:
In particular, if an incorrect loading of the wash rack is detected, visualizing the correct loading of the wash rack and/or loading instructions to correct the loading and/or visualizing the incorrectly arranged wash rack, in particular by means of an augmented reality apparatus.
Correcting the loading of the wash rack.

This allows the user to quickly and easily correct the arrangement of the items to be cleaned.

Preferably, the capture of the loading of the wash rack and/or the checking of the loading is carried out during the loading of the wash rack.

This makes it easy to ensure that the user performs the loading correctly.

Preferably, the test method is recorded by the recording device of the augmented reality apparatus.

This allows for easy retesting in the event of poor cleaning of the items to be cleaned. The calculations of the test method can either be calculated on the device that captures the data (such as the augmented reality apparatus) and/or on an external device or server, which can be located on site and/or in the cloud.

The problem is solved by an augmented reality apparatus which is designed to perform the steps of a method as described above. In particular, the augmented reality apparatus comprises a visualization device for visualizing pictorial and/or animated loading instructions, preferably mixed reality glasses, and/or a playback device for playing acoustic loading instructions, preferably a speaker and/or headphones, and/or a recording device for capturing real wash racks and real items to be cleaned, preferably identification features and/or positioning features.

Such an augmented reality apparatus allows a wash rack to be loaded quickly and correctly.

The augmented reality apparatus may comprise fasteners for mounting the augmented reality apparatus to the head of a user.

The fasteners may be an elastic band that is adjustable in length. The augmented reality apparatus may comprise a database of loading instructions and/or 3D models of items to be cleaned and/or wash racks and/or may be connected to a database via cable and/or wireless. The augmented reality apparatus may be designed to allow a user to interact with 3D models of items to be cleaned and/or wash racks, in particular by gestures and/or acoustic instructions. In particular, the augmented reality apparatus is a mixed reality apparatus.

The task is also solved by a loading system. The loading system comprises at least one augmented reality apparatus as described above and at least one wash rack. In particular, the loading system comprises a database with loading instructions and/or with virtual 3D models of real items to be cleaned and/or of real wash racks.

This system allows a wash rack to be loaded quickly and correctly. The loading system can comprise a capturing device which is designed to capture items to be cleaned and/or a recording device of the at least one augmented reality apparatus can be designed to capture items to be cleaned. The loading system can be designed to select loading instructions of the captured items to be cleaned, preferably to calculate an ideal distribution of the items to be cleaned on one or more wash racks, to select corresponding loading instructions and to send them to one or more augmented reality apparatuses. A separate capturing device allows incoming items to be cleaned to be captured quickly and easily and distributed to different wash racks. When the items to be cleaned are captured by the augmented reality apparatus recording device, the augmented reality apparatus can select and play the loading instructions for that item to be cleaned, speeding up the process while ensuring correct selection of loading instructions. The loading system may comprise a database of all individually identifiable items to be cleaned. The loading system may be adapted to log the cleaning of each individually identifiable item to be cleaned, in particular with a still image of the loading of the wash rack or racks used. The loading system can be designed to log loading data such as the date and/or time of loading and/or cleaning and/or the cleaning system used and/or identification of a user together with images of the recording device and/or cleaning data. The loading system can be designed to identify items to be cleaned. The loading system may include a server configured to collect loading data. The server may be designed to detect inefficient processes and/or optimize loading instructions.

The task is finally solved by a method for cleaning items to be cleaned, comprising the steps of:
Loading a wash rack by means of a loading method as described above,
in particular testing the loading of the wash rack by means of a test method as described above, preferably during loading and/or after completion of loading,
introducing the loaded wash rack into a cleaning system,
cleaning of the items to be cleaned by the cleaning system.

In this way, complete cleaning of the items to be cleaned is easily ensured.

The step of cleaning the items to be cleaned may be designed to occur only upon release for cleaning, preferably by a user and/or an augmented reality apparatus.

The cleaning system can perform several cleaning steps. The cleaning system may also comprise a recording device that allows verification of correct loading of the wash rack and/or correct execution of cleaning. The cleaning may include washing and/or sterilizing and/or drying the items to be cleaned. The cleaning system may be designed to wash and/or sterilize and/or dry the items to be cleaned.

The invention is explained in detail with reference to the figures. The figures show:

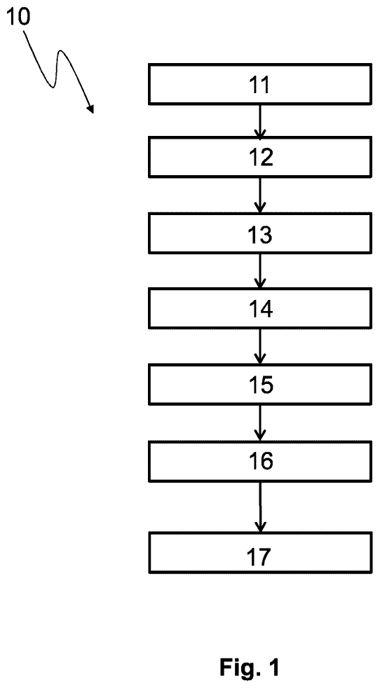

FIG. 1: A schematic representation of a loading method

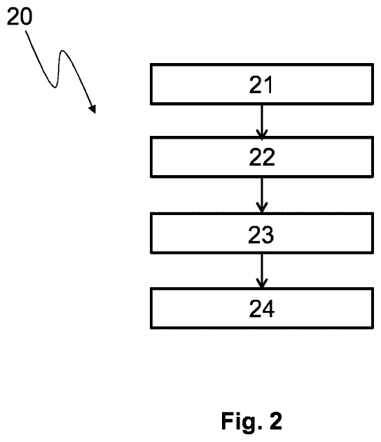

FIG. 2: A schematic representation of a test method

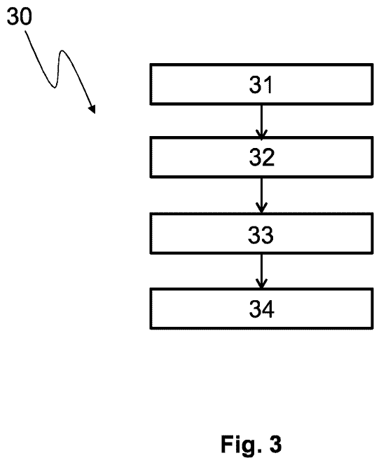

FIG. 3: A schematic representation of a cleaning method

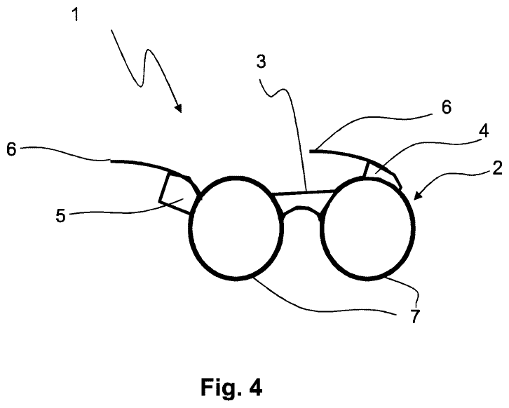

FIG. 4: A schematic representation of an augmented reality apparatus

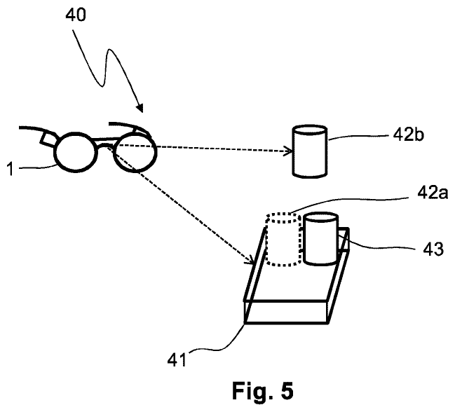

FIG. 5: A schematic representation of a loading system

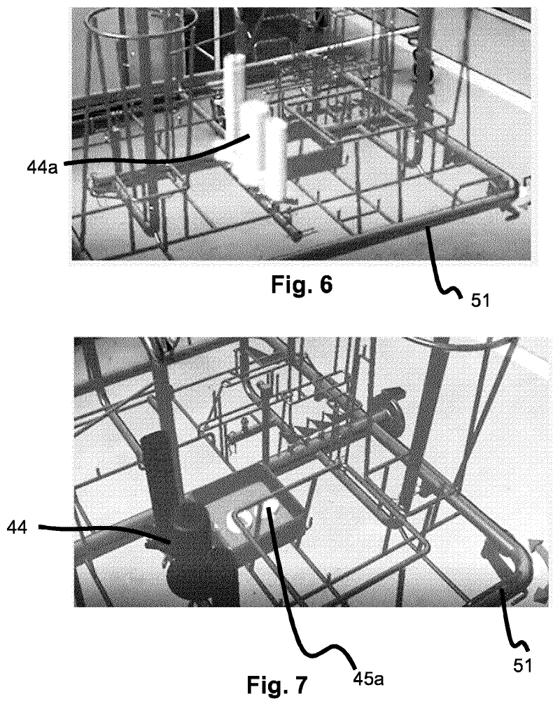

FIG. 6: An illustration of a first loading instruction

FIG. 7: An illustration of a second loading instruction

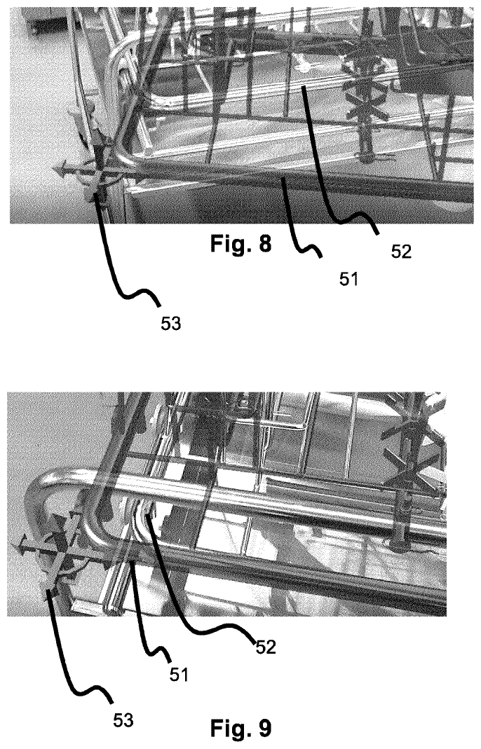

FIG. 8: An illustration of a superimposed representation of a wash rack with a rotated virtual wash rack

FIG. 9: An illustration of a superimposed representation of a wash rack with a shifted virtual wash rack

FIG. 1 shows a schematic representation of a loading method 10 for loading a wash rack with items to be cleaned in a cleaning system.

In the loading method 10, an augmented reality apparatus is provided in a first step 11. In this case, this augmented reality apparatus is designed in such a way that interactions of a user with the virtual reality are possible, i.e. a mixed reality can be achieved.

In a further step 12, a wash rack is provided. Wash racks are designed to hold items to be cleaned so that the items to be cleaned can be thoroughly cleaned. For example, they may have sufficient openings to allow cleaning liquids to pass through. Rotary arms can also be arranged on wash racks. Wash racks can be trolleys, baskets and similar containers.

In a next step 13, loading instructions are loaded and started by input from a user. This is done by gestures of the user, which are recorded and evaluated by a recording device of the augmented reality apparatus, as well as by acoustic instructions of the user. The recording device comprises at least one camera and at least one microphone. In addition, the real wash rack can be captured by the recording device and the representation of a virtual wash rack can be projected onto or next to the real wash rack accordingly.

In step 14, the augmented reality apparatus then issues loading instructions for loading the wash rack with items to be cleaned. This is done with a visual representation and/or acoustic instructions by the augmented reality apparatus. For this purpose, the augmented reality apparatus comprises at least one display device for visual representation of the loading instructions, in this case glasses, which the user puts on, and a playback device, in this case a speaker, which plays the acoustic instructions.

Items to be cleaned are objects that are to be cleaned. Items to be cleaned can be ampoules, tools, clips and similar objects.

The augmented reality apparatus comprises 3D models of items to be cleaned and wash racks, so that the real wash racks and items to be cleaned can be easily superimposed on or visualized next to the 3D models by means of the display device. Then, in step 15, the wash rack is loaded with items to be cleaned by a user according to the loading instructions provided. The user can simply transfer the desired position of the virtual 3D models to the real position of the items to be cleaned using the superimposed or adjacent display. Overlaying the real wash rack loading with the correct virtual wash rack loading allows the user to easily identify which position is correct and where the real items to be cleaned are incorrectly arranged.

In step 16, the completed loading step is captured by input from the user. This input is made by an acoustic or visual command from the user, which is recorded by a recording device, here at least a microphone or a camera, of the augmented reality apparatus and executed by the augmented reality apparatus.

In step 17, the loading instructions of another loading step are loaded.

Compared to the conventional loading method, the loading method of the invention is less error-prone and faster to perform. By using glasses, which the user puts on, the user can easily use his hands for loading the wash rack and for interacting with the virtual representation.

FIG. 2 shows a schematic representation of a test method for checking the correct loading of a wash rack.

In a first step 21, a wash rack is loaded by means of a loading method 10 as shown in FIG. 1.

Then, in step 22, the test is started by input from the user via an acoustic command which is recorded by the recording device of the augmented reality apparatus.

In step 23, the loading of the wash rack is captured by the camera of the recording device of the augmented reality apparatus.

Then, in step 24, it is checked whether the wash rack is correctly loaded. Here, the real, loaded wash rack is recorded by the recording device and compared by the augmented reality apparatus with a correctly loaded wash rack. If the wash rack is not loaded correctly, a warning is issued. The deviating arrangement is highlighted in the superimposed display so that the user can see at a glance where which items to be cleaned are positioned incorrectly. The user corrects the position of the incorrectly arranged items to be cleaned based on the display. If the wash rack is loaded correctly, an acoustic signal gives the approval for cleaning.

The test method 20 is recorded by means of a still image of the correctly or correctedly loaded wash rack.

FIG. 3 shows a schematic representation of a cleaning method 30.

In a first step 31, the wash rack is loaded by means of a loading method 10 (shown in FIG. 1).

In a second step 32, the loading is checked by means of a test method 20 (see FIG. 3).

If a correct or corrected loading is determined, the loaded wash rack is introduced into a cleaning system in step 33.

In step 34, the items to be cleaned are cleaned by the cleaning system.

FIG. 4 shows a schematic representation of an augmented reality apparatus 1. The augmented reality apparatus 1 comprises a visualization device 2, a recording device 3, a playback device 4 and a computer 5.

The visualization device 2 is here a pair of glasses with two display surfaces 7 onto which the display of the loading instructions is projected.

The recording device 3 comprises at least one camera and at least one microphone. The camera is designed to recognize both wash racks and items to be cleaned and to record gestures made by the user. At least one microphone is designed to record acoustic commands from the user. The user can use gestures to interact with the virtual 3D models and thus achieve a mixed reality.

The playback device 4 is a speaker for playing acoustic loading instructions.

The computer 5 comprises a database of loading instructions and is adapted to perform a loading method 10 (FIG. 1), a test method (FIG. 2) and a cleaning method (FIG. 3). The database also includes 3D models and images of the wash rack and items to be cleaned. The computer is configured to evaluate acoustic and visual signals from the recording device 3 and to load, play, pause, check and log loading instructions accordingly.

The augmented reality apparatus 1 comprises fasteners 6 for mounting on a user's head. Here, the fasterners 6 are brackets for mounting on the ears of a user. This allows the device to be put on and taken off quickly. However, should a more secure mounting be found, an elastic, adjustable strap or similar fasterners are also conceivable.

The user puts on the augmented reality apparatus 1 and selects a loading in a menu using gestures. The loading instructions for this loading are retrieved from the database of the computer 5 and shown to the user with the display device 2.

FIG. 5 shows a schematic representation of a loading system 40. The loading system 40 comprises an augmented reality apparatus 1 and a wash rack 41. In a first step, the user has already loaded the wash rack 41 with an item to be cleaned 43. The augmented reality apparatus 1 now superimposes a loading instruction 42a for a real item to be cleaned 42b on the real wash rack 41.

FIG. 6 shows an illustration of a first loading instruction. Here, an augmented reality apparatus 1 (see FIG. 4) overlays a real table with a virtual representation of a wash rack 51 and an item to be cleaned 44a.

During loading, the user follows these loading instructions and arranges the real items to be cleaned on the real wash rack at the position that corresponds to the arrangement of the virtual items to be cleaned 44a on the virtual wash rack 51. A user completes the loading step with a voice command. The augmented reality apparatus 1 (see FIG. 4) switches to a second loading instructions for a second loading step.

FIG. 7 shows an illustration of a second loading instruction. Here too, as in FIG. 6, a real table is superimposed by the augmented reality apparatus 1 with the virtual representation of a wash rack 51 and a second loading instruction 45a. Further, this virtual representation shows a completed first loading instruction 44, which may be shown in a different color than the pending loading instruction 45a.

FIG. 8 shows an illustration of a superimposed representation of a wash rack 52 with a rotated virtual wash rack 51. The user can use interactions (see 53) to rotate the virtual wash rack 51 so that the representation of the virtual wash rack 51 matches the alignment of the real wash rack 52.

FIG. 9 shows an illustration of a superimposed representation of a wash rack 52 with a shifted virtual wash rack 51. The user can use interactions (see 53) to shift the virtual wash rack 51 so that the representation of the virtual wash rack 51 matches the alignment of the real wash rack 52.

1-26. (canceled)

27. A loading method for loading a wash rack for cleaning in a cleaning system comprising the steps of:
providing an augmented reality apparatus to a user;
providing a wash rack;
providing loading instructions via the augmented reality apparatus for loading the wash rack; and
loading the wash rack with items to be cleaned according to the given loading instructions.

28. The loading method according to claim 27, wherein the loading instructions are visualized to the user by virtually displaying 3D models of a loaded wash rack using the augmented reality apparatus.

29. The loading method according to claim 28, wherein the loading instructions are visualized in animated form.

30. The loading method according to claim 28, wherein virtual loading instructions are projected onto real positions of the wash rack by the augmented reality apparatus.

31. The loading method according to claim 27, further comprising the following steps:
visualizing at least one of the items to be cleaned and the wash rack; and
collecting at least one of the items to be cleaned and the wash rack to be used.

32. The loading method according to claim 27, wherein the augmented reality apparatus comprises at least one recording device for recording information.

33. The loading method according to claim 27, wherein the wash rack and at least one of the items to be cleaned comprise positioning features for detecting the alignment of the at least one of the items to be cleaned and the wash rack.

34. The loading method according to claim 28, wherein the method further comprises aligning the 3D models by the user.

35. The loading method according to claim 27, wherein the method further comprises the following steps:
selection of loading instructions by the user by means of interaction with the augmented reality apparatus; and
visualizing the selected loading instructions.

36. The loading method according to claim 27, wherein the method further comprises capturing at least one of the items to be cleaned and the wash rack to be used.

37. The loading method according to claim 36, wherein the method further comprises the following steps:
recognizing one or more positioning features of at least one of the captured wash racks and items to be cleaned,
aligning one or more virtual 3D models of at least one of the wash racks and the items to be cleaned according to these positioning features
visualizing a superimposed representation of at least one of the wash racks and items to be cleaned with the aligned virtual 3D models.

38. The loading method according to claim 36, wherein the method further comprises the following steps:
recognizing one or more positioning features of at least one of the captured wash racks and items to be cleaned;
indicating position corrections of the items to be cleaned by means of the positioning features; and
correcting, by the user, the position of the items to be cleaned according to the position correction indication.

39. The loading method according to claim 27, wherein the augmented reality apparatus comprises at least one speaker and one earphone for reproducing acoustic loading instructions.

40. The loading method according to claim 27, wherein at least one of the items to be cleaned and the wash rack comprise at least one identification feature for identifying at least one of the items to be cleaned and the wash rack.

41. The loading method according to claim 27, wherein the loading method further comprises providing a database, wherein the database comprises loading instructions for loading wash racks.

42. The loading method according to claim 41, wherein the database comprises virtual 3D models of at least one of the items to be cleaned and of real wash racks.

43. The loading method according to claim 27, wherein the loading instructions further comprise information on additional cleaning devices to be used, for specific items to be cleaned, and wherein the loading method further comprises the step of positioning, arranging, and/or mounting, by the user, at least one additional cleaning device to be used according to the loading instructions.

44. The loading method according to claim 32, wherein the wash rack and the items to be cleaned are recorded by the recording device.

45. A test method for testing the loading of a wash rack, comprising the steps of:
loading a wash rack;
capturing the loading of the wash rack;
checking whether the wash rack is correctly loaded; and
if the wash rack is not correctly loaded, issuing a warning, otherwise issuing a release for cleaning.

46. The test method according to claim 45, wherein the test method further comprises the following steps:
displaying at least one of: the correct loading of the wash rack, the loading instructions for correcting the loading, and/or one or more incorrectly arranged wash items; and
correcting the loading of the wash rack.

47. The test method according to claim 45, wherein at least one of the capturing of the loading of the wash rack and the checking of the loading is carried out during the loading of the wash rack.

48. A method for cleaning items to be cleaned, comprising the steps of:
loading a wash rack by means of a loading method according to claim 27;
introducing the loaded wash rack into a cleaning system; and
cleaning the items to be cleaned by the cleaning system.
